(19) United States
(12) Patent Application Publication
(10) Pub. No.: US 2025/0108655 A1
(43) Pub. Date: Apr. 3, 2025

(54) Writing Apparatus Holder for Visually Impaired Users

(71) Applicant: Daniel Bonn, Redondo Beach, CA (US)

(72) Inventor: Daniel Bonn, Redondo Beach, CA (US)

(21) Appl. No.: 18/476,514

(22) Filed: Sep. 28, 2023

(51) Int. Cl. B43K 31/00

(52) U.S. Cl. CPC B43K 31/00

(57) ABSTRACT

An apparatus for holding and identifying a wax writing instrument for visually impaired users. The wax writing instrument holder includes a body portion with an internal receptacle extending longitudinally at least partially from a first end of the body portion toward a second end opposite the first end. A spike is positioned within the internal receptacle extending toward the first end. The spike is configured to at least partially pierce an end of a wax writing instrument positioned within the internal receptacle. A tactile color label indicative of a color of the wax writing instrument is positioned on the body portion.

### TECHNICAL FIELD

The present disclosure generally relates to writing apparatus holders, and more particularly relates to crayon holders with integrated markings for visually impaired users.

### BACKGROUND

Writing instruments such as colored pencils, crayons, and markers are typically labeled on the writing instruments themselves. However, for users with visual impairments, it may be difficult to read to discern a particular color, set of colors, type, pattern, or other characteristic of the writing instrument. As such, users of writing instruments may require assistance from others to properly identify and handle these writing instruments.

### SUMMARY

In an embodiment, a wax writing instrument holder includes a body portion with an internal receptacle extending longitudinally at least partially from a first end of the body portion toward a second end opposite the first end. A spike is positioned within the internal receptacle extending toward the first end. The spike is configured to at least partially pierce an end of a wax writing instrument positioned within the internal receptacle. A tactile color label indicative of a color of the wax writing instrument is positioned on the body portion.

One or more of the following features may be included. The tactile color label may be a braille representation of the color of the wax writing instrument. The spike may be configured to at least partially pierce a non-writing end of the wax writing instrument. The body portion may be a rectangular prism and includes square-shaped ends. The tactile color label may be positioned on a longitudinal face of the body portion. The body portion may be a cylinder. The body portion may be a triangular prism and includes triangle-shaped ends. The tactile color label may be positioned on a longitudinal face of the body portion. The body portion may be one of: a pentagonal prism; a hexagonal prism; a heptagonal prism; and an octagonal prism. A color of the body portion may correspond to a color described by the tactile color label. A text label may be positioned on the body portion indicative of a color of the wax writing instrument.

According to another implementation, a wax writing instrument holder includes a body portion with an internal receptacle extending longitudinally at least partially from a first end of the body portion toward a second end opposite the first end. The body portion is a rectangular prism. A spike is positioned within the internal receptacle extending toward the first end. The spike is configured to at least partially pierce an end of a wax writing instrument positioned within the internal receptacle. A tactile color label is positioned on the body portion indicative of a color of the wax writing instrument and the tactile color label is a braille representation of the color of the wax writing instrument.

One or more of the following features may be included. The spike may be configured to at least partially pierce a non-writing end of the wax writing instrument. The tactile color label may be positioned on a longitudinal face of the body portion. A color of the body portion may correspond to a color described by the tactile color label. A text label may be positioned on the body portion indicative of a color of the wax writing instrument.

### BRIEF DESCRIPTION OF THE DRAWINGS

FIGS. 1A-1B are side perspective views of a wax writing instrument holder, according to an example embodiment;

FIGS. 2A-2B are side perspective views of the wax writing instrument holder of FIGS. 1A-1B with a wax writing instrument positioned within the wax writing instrument holder, according to an example embodiment;

FIGS. 3A-3B are side perspective views of the wax writing instrument holder of FIGS. 1A-1B with a wax writing instrument positioned within the wax writing instrument holder and a text label, according to an example embodiment;

FIGS. 4A-4B are side perspective views of a wax writing instrument holder with a cylindrical body portion, according to an example embodiment;

FIG. 5A is side perspective view of a wax writing instrument holder with a body portion in the form of a triangular prism, according to an example embodiment;

FIG. 5B is side perspective view of a wax writing instrument holder with a body portion in the form of a pentagonal prism, according to an example embodiment;

FIG. 5C is side perspective view of a wax writing instrument holder with a body portion in the form of a hexagonal prism, according to an example embodiment;

FIG. 6A is side perspective view of a wax writing instrument holder with a body portion in the form of a heptagonal prism, according to an example embodiment; and

FIG. 6B is side perspective view of a wax writing instrument holder with a body portion in the form of an octagonal prism, according to an example embodiment.

### DETAILED DESCRIPTION OF EXAMPLE EMBODIMENTS

In general, consistent with the present disclosure, a writing instrument, such as a crayon, a colored pencil, a marker, or the like, may be provided with a holder that identifies the writing instrument. The holder may, for example, provide tactile indication of the type or color of a particular writing instrument and/or be utilized for various other reasons. A body portion of the writing instrument holder may include an internal receptacle extending longitudinally at least partially from a first end of the body portion toward a second end opposite the first end. A spike may be positioned within the internal receptacle extending toward the first end, the spike may be configured to at least partially pierce an end of a wax writing instrument positioned within the internal receptacle. A tactile color label may be positioned on the body portion indicative of a color of the wax writing instrument.

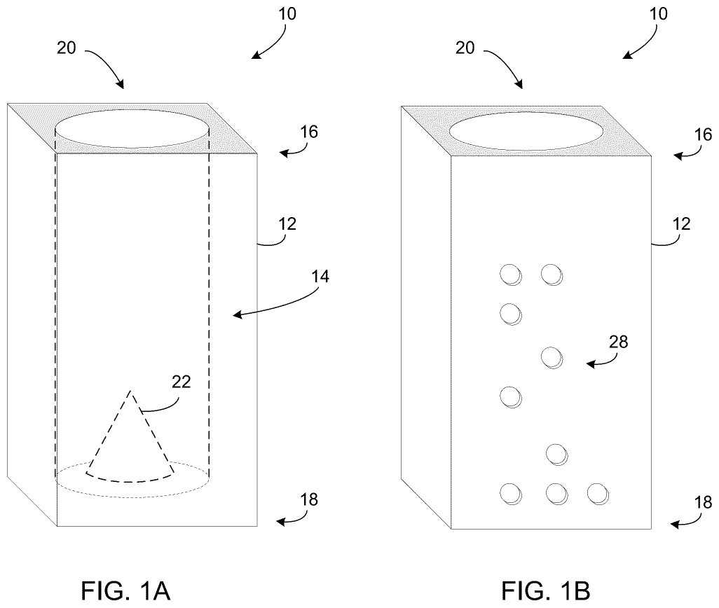

For example, and referring generally to FIGS. 1A through 6B, a wax writing instrument holder (e.g., wax writing instrument holder 10) may include a body portion (e.g., body portion 12) with an internal receptacle (e.g., internal receptacle 14) extending longitudinally at least partially from a first end (e.g., first end 16) of the body portion toward a second end (e.g., second end 18) opposite the first end. In some embodiments, body portion 12 is formed from any combination of materials including plastics, metals, metal alloys, natural materials (e.g., wood). In one embodiment, body portion 10 is formed from molded plastic to minimally interfere with use of the wax writing instrument. While nylon material may be suitable plastic material for molding body portion 12, it will be appreciated that various additional and/or alternative materials may be utilized, including, but not limited to, polyethylene, polypropylene, ABS, polyester, and the like. In some embodiments, internal receptacle 14 is a generally cylindrical receptacle configured to receive a correspondingly cylindrical wax writing instrument. However, it will be appreciated that internal receptacle 14 may be defined in various shapes within the scope of the present disclosure. Internal receptable 14 may extend longitudinally along the length of body portion 12 but not through the opposite end. In this manner, internal receptacle 14 defines an opening (e.g., opening 20).

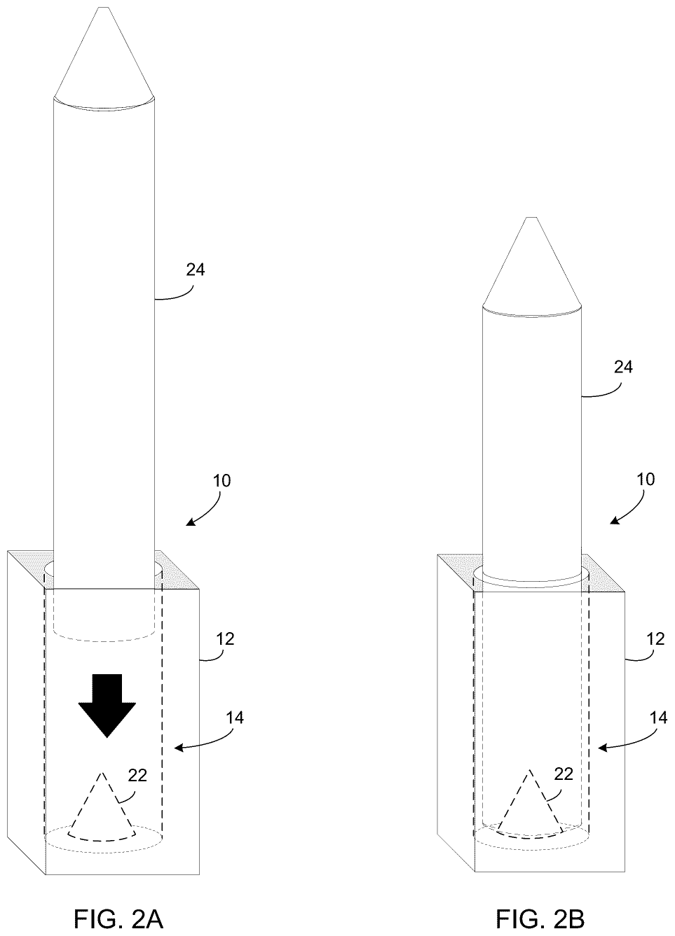

As shown in FIG. 1A, a three-dimensional side view of wax writing instrument holder 10 is shown with dashed lines indicative of the internal edges and structure of internal receptacle 14 within body portion 12. As shown in FIG. 1A, a spike (e.g., spike 22) positioned within internal receptacle 14 extending toward first end 16, spike 22 configured to at least partially pierce an end of a wax writing instrument positioned within internal receptacle 14. Referring also to FIGS. 2A-2B, a non-writing end of wax writing instrument (e.g., wax writing instrument 24) is inserted into opening 20 and slid longitudinally into internal receptacle 14 until wax writing instrument 24 makes physical contact with spike 22. Wax writing instrument 24 is secured to body portion 12 by pressing wax writing instrument 24 until spike 22 pierces at least partially into the non-writing end of wax writing instrument 24. Spike 22 is shown in FIGS. 1A-6B as a generally conical structure with a sufficiently sharpened point to at least partially pierce the surface of non-writing end of wax writing instrument 24. However, it will be appreciated that spike 22 may include a columnar structure (e.g., like a spear point or needle end) or a barbed protuberance configured to prevent wax writing instrument 24 from being removed from body portion 12.

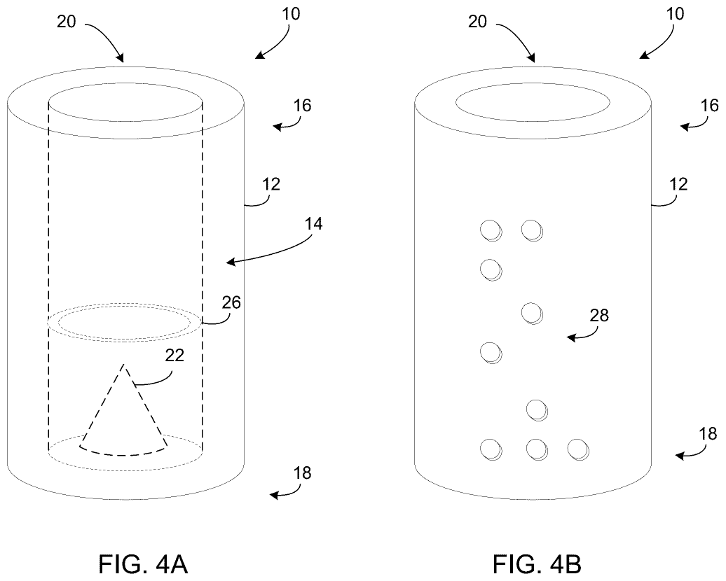

In some embodiments, internal receptacle 14 includes retention mechanisms in addition to, or alternatively to, spike 22. For example, and as shown in FIG. 4A, internal receptacle 14 may include generally cylindrical ring-shaped projections (e.g., retention projection 26) positioned along the interior surface of internal receptacle 14. In some embodiments, retention projection 26 is configured to press along the exterior surface of wax writing instrument 24 as wax writing instrument 24 is inserted into internal receptacle 14. In this example, retention projection 26 retains wax writing instrument 24 within body portion 12 such that wax writing instrument holder 10 is held and used in writing.

In some embodiments, a tactile color label (e.g., tactile color label 28) is positioned on body portion 12 indicative of a color of wax writing instrument 24. For example, tactile color label 28 is a label formed from one or more raised features that are read by feeling the label (e.g., with a user's finger) as opposed to reading visually. Tactile labels are typically used to help visually impaired users read or access information by physically feeling the raised features of the label indicative of letters, numbers or other symbols. In one example, tactile color label 28 is a braille representation of the color of the wax writing instrument. In some embodiments, tactile color label 28 is positioned on a longitudinal face of body portion 12. For example, and as shown in FIG. 1B, tactile color label 28 is positioned on a longitudinal face of body portion 12 and describes the color “red” in braille. In some embodiments, tactile color label 28 is integrally formed into body portion 12 or is affixed to body portion 12. For example, tactile color label 28 is a separate label that is affixed to a longitudinal face of body portion 12. In one example, tactile color label 28 is a label that is affixed to body portion 12 using an adhesive applied to body portion 12 or from tactile color label 28 (e.g., like a sticker).

In some embodiments, a color of body portion 12 may correspond to a color described by the tactile color label. For example, body portion 12 may be colored in a color corresponding to a color described by tactile color label 28. In one example, at least a portion of body portion 12 may be painted with the color described by tactile color label 28. For example, a portion (e.g., an end or a particular spot) may be painted or provided with a colored sticker corresponding to the color described by tactile color label 28. In another example, body portion 12 may be molded from colored plastic corresponding to the color described by tactile color label 28.

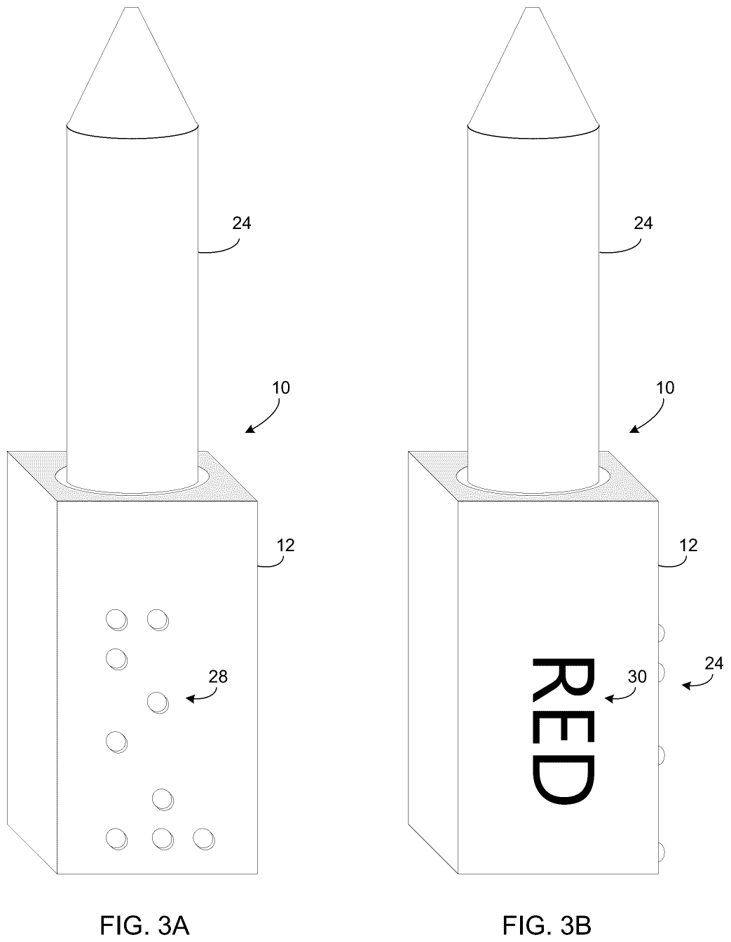

In some embodiments, a text label (e.g., text label 30) is positioned on body portion 12 indicative of a color of wax writing instrument 24. Referring also to FIG. 3B, wax writing instrument holder 10 is shown with wax writing instrument 24 placed within internal receptacle 14 and pressed into spike 22. In this example, a text label (e.g., text label 30) is shown describing the color “red” in the English language. However, it will be appreciated that text label 30 may be in any font or language describing any color within the scope of the present disclosure. In some embodiments, text label 30 may describe other features that differentiate wax writing instrument 24 from other wax writing instruments (e.g., thickness, shade of color, inclusion of glitter or other materials in the wax, etc.). In one embodiment and as shown in FIG. 3B, tactile color label 28 is positioned on a first longitudinal face of body portion 12 while text label 28 is positioned on a second longitudinal face of body portion 12 that is separate from the first longitudinal surface.

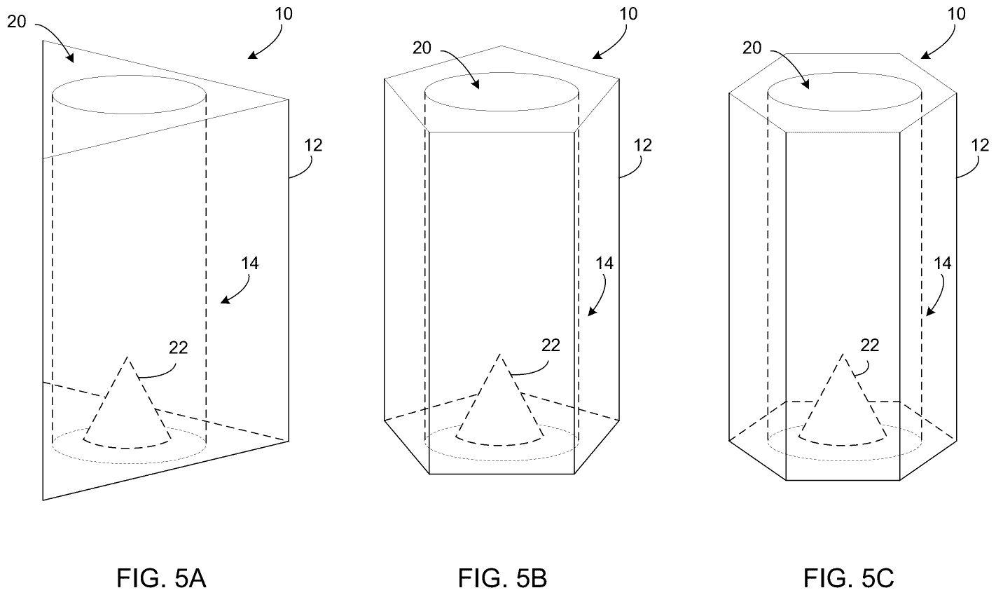

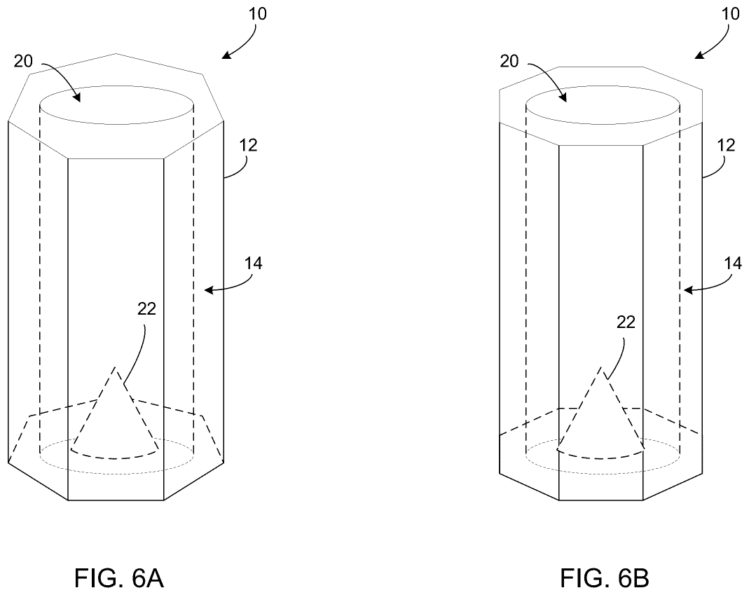

In some embodiments, body portion 12 may be provided in different shapes. For example, different shapes may make wax writing instrument holder 10 easier to hold or write with while other shapes may prevent wax writing instrument 24 from rolling. In one example and as shown in FIGS. 1A-3B, body portion 10 is a rectangular prism. In this example, body portion 12 includes square-shaped ends. In another example and as shown in FIGS. 4A-4B, body portion 10 is a cylinder. In this example, body portion 12 includes circular or elliptical ends. In another example and referring also to FIG. 5A, body portion 12 is a triangular prism and includes triangle-shaped ends. In another example and referring also to FIG. 5B, body portion 12 is a pentagonal prism with pentagon-shaped ends. In another example and referring also to FIG. 5C, body portion 12 is a hexagonal prism with hexagon-shaped ends. In another example and as shown in FIG. 6A, body portion 12 is a heptagonal prism with heptagon-shaped ends. In another example and as shown in FIG. 6B, body portion 12 is an octagonal prism with octagon-shaped ends. While several examples have been provided for the shapes of body portion 12, it will be appreciated that body portion 12 may be in any shape within the scope of the present disclosure.

A number of embodiments have been described. Nevertheless, it will be understood that various modifications may be made. Accordingly, other implementations are within the scope of the following claims.

What is claimed is:

1. A wax writing instrument holder comprising:
a body portion with an internal receptacle extending longitudinally at least partially from a first end of the body portion toward a second end opposite the first end;
a spike positioned within the internal receptacle extending toward the first end, the spike configured to at least partially pierce an end of a wax writing instrument positioned within the internal receptacle; and
a tactile color label positioned on the body portion indicative of a color of the wax writing instrument.

2. The wax writing instrument holder of claim 1, wherein the tactile color label is a braille representation of the color of the wax writing instrument.

3. The wax writing instrument holder of claim 1, wherein the spike is configured to at least partially pierce a non-writing end of the wax writing instrument.

4. The wax writing instrument holder of claim 1, wherein the body portion is a rectangular prism.

5. The wax writing instrument holder of claim 4, wherein the body portion includes square-shaped ends.

6. The wax writing instrument holder of claim 4, wherein the tactile color label is positioned on a longitudinal face of the body portion.

7. The wax writing instrument holder of claim 1, wherein the body portion is a cylinder.

8. The wax writing instrument holder of claim 1, wherein the body portion is a triangular prism.

9. The wax writing instrument holder of claim 8, wherein the body portion includes triangle-shaped ends.

10. The wax writing instrument holder of claim 9, wherein the tactile color label is positioned on a longitudinal face of the body portion.

11. The wax writing instrument holder of claim 1, wherein the body portion is one of:
a pentagonal prism;
a hexagonal prism;
a heptagonal prism; and
an octagonal prism.

12. The wax writing instrument holder of claim 1, wherein a color of the body portion corresponds to a color described by the tactile color label.

13. The wax writing instrument holder of claim 1, further comprising:
a text label positioned on the body portion indicative of a color of the wax writing instrument.

14. The wax writing instrument holder of claim 1, further comprising:
one or more retention projections within the internal receptacle configured to circumferentially engage an exterior surface of the wax writing instrument positioned within the internal receptacle.

15. A wax writing instrument holder comprising:
a body portion with an internal receptacle extending longitudinally at least partially from a first end of the body portion toward a second end opposite the first end, wherein the body portion is a rectangular prism;
a spike positioned within the internal receptacle extending toward the first end, the spike configured to at least partially pierce an end of a wax writing instrument positioned within the internal receptacle; and
a tactile color label positioned on the body portion indicative of a color of the wax writing instrument, wherein the tactile color label is a braille representation of the color of the wax writing instrument.

16. The wax writing instrument holder of claim 15, wherein the spike is configured to at least partially pierce a non-writing end of the wax writing instrument.

17. The wax writing instrument holder of claim 15, wherein a color of the body portion corresponds to a color described by the tactile color label.

18. The wax writing instrument holder of claim 15, wherein the tactile color label is positioned on a first longitudinal face of the body portion.

19. The wax writing instrument holder of claim 15, further comprising:
a text label positioned on the body portion indicative of a color of the wax writing instrument.

20. The wax writing instrument holder of claim 18, wherein the text label is positioned on a second longitudinal face of the body portion.
